(19) United States
(12) Patent Application Publication
(10) Pub. No.: US 2019/0251525 A1
(43) Pub. Date: Aug. 15, 2019

(54) Trading Software Platform and Method of Use

(71) Applicants: Kristopher Barnings, Amarillo, TX (US); Eduardo Adair Fragoso, Amarillo, TX (US)

(72) Inventors: Kristopher Barnings, Amarillo, TX (US); Eduardo Adair Fragoso, Amarillo, TX (US)

(21) Appl. No.: 16/274,177

(22) Filed: Feb. 12, 2019

Related U.S. Application Data
(60) Provisional application No. 62/629,493, filed on Feb. 12, 2018.

(51) Int. Cl. G06Q 20/06; G06Q 20/22

(52) U.S. Cl. CPC G06Q 20/065; G06Q 20/22

(57) ABSTRACT

A method of using a trading system of a trading system is disclosed. Comprising storing a two or more credits belonging to a two or more among a two or more consumer users in a trading system server. Storing a mapping between the two or more credits and one or more merchant users. Facilitating a trade event of the trade event among two or more among the two or more consumer users according to a trade parameters. Assigning ownership of the two or more credits to new owners among the two or more consumer users according to the trade parameters.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant

### BRIEF SUMMARY OF THE INVENTION

A method of using a trading system of a trading system is disclosed. Comprising storing a two or more credits belonging to a two or more among a two or more consumer users in a trading system server. Storing a mapping between said two or more credits and one or more merchant users. Facilitating a trade event of said trade event among two or more among said two or more consumer users according to a trade parameters. Assigning ownership of said two or more credits to new owners among said two or more consumer users according to said trade parameters.

### BRIEF DESCRIPTION OF THE SEVERAL VIEWS OF THE DRAWING

FIG. 1 illustrates a flow chart view of a network diagram 102.

FIGS. 2A, 2B, 2C, 2D and 2E illustrate a perspective overview view of a mobile phone 200a, a personal computer 200b, a tablet 200c, a wearable computer 200d and a smartphone 200e, respectively.

FIGS. 3A, 3B and 3C illustrate view of an address space 302, an address space 302a and an address space 302d, respectively.

FIG. 4 illustrates a communication diagram 400.

FIG. 5 illustrates view of an application interaction diagram 500 demonstrating interaction between a device application 502 and a server application 506.

FIG. 6 illustrates view of a server interaction diagram 600.

FIGS. 7A and 7B illustrate an elevated back side view of a first merchant card 700a and view of a first consumer user 118a with one or more merchant cards 700, respectively.

FIG. 8 illustrates a flow chart view of a initial accounts status 800.

FIG. 9 illustrates a flow chart view of an assignment view 900.

FIG. 10 illustrates view of an adjusted credits view 1000.

FIG. 11 illustrates view of a method of using a trading system 1100.

FIG. 12 illustrates a trading system records detail 1200 of a trading system data records 508.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

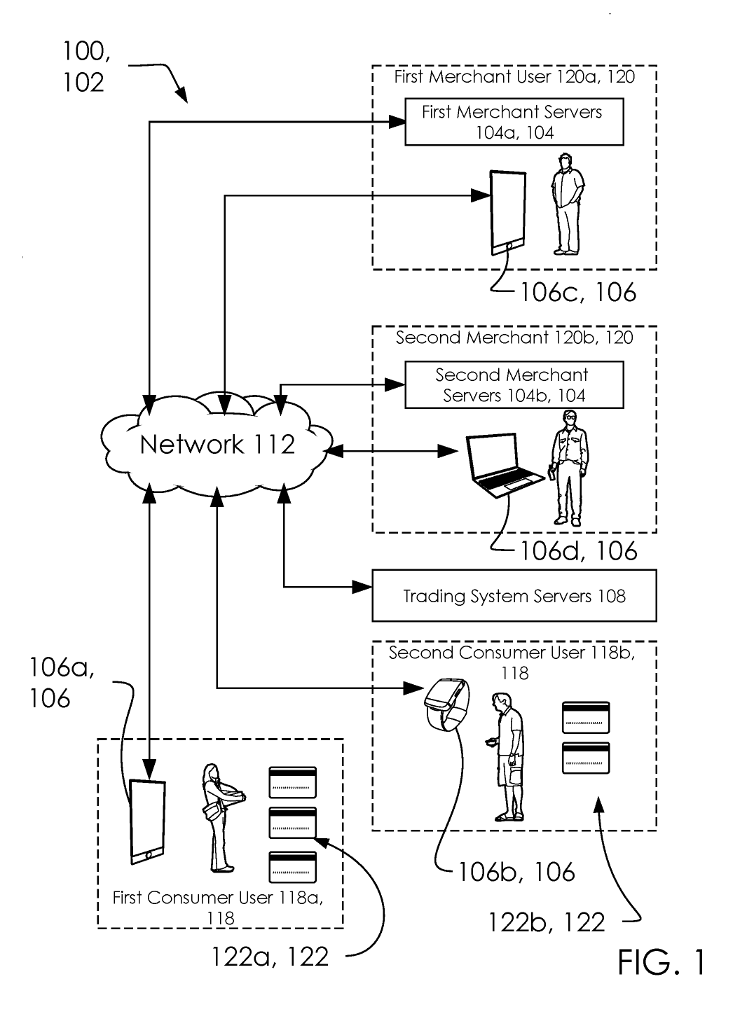

FIG. 1 illustrates a flow chart view of a network diagram 102.

In one embodiment, said network diagram 102 can comprise an user computers 106, a trading system server 108 and a network 112.

In one embodiment, said user computers 106 can comprise a first consumer computer 106a, a second consumer computer 106b, a first merchant computer 106c and a second merchant computer 106d. In one embodiment, a trading system 100 can comprise a merchant servers 104, said user computers 106, said trading system server 108 and said network 112. In one embodiment, said merchant servers 104 can comprise a first merchant server 104a, a second merchant server 104b and a third merchant server 104c.

In one embodiment, a two or more consumer users 118 can comprise a first consumer user 118a and a second consumer user 118b. One or more merchant users 120 can comprise a first merchant user 120a and a second merchant user 120b.

In one embodiment, a plurality of user account cards 122 can comprise a first user account cards 122a and a second user account cards 122b.

In one embodiment, said trading system 100 can comprise a hardware and software system for managing account benefits and balances as between said one or more merchant users 120 and said two or more consumer users 118.

Said network 112 can be a local area network (LAN), a wide area network (WAN), a piconet, or a combination of LANs, WANs, or piconets. One illustrative LAN is a network within a single business. One illustrative WAN is the Internet.

In one embodiment, said trading system server 108 represents at least one, but can be many servers, each connected to said network 112. Said trading system server 108 can connect to a data storage; which can comprise any suitable long-term or persistent storage device and, further, may be separate devices or the same device and may be collocated or distributed (interconnected via any suitable communications network).

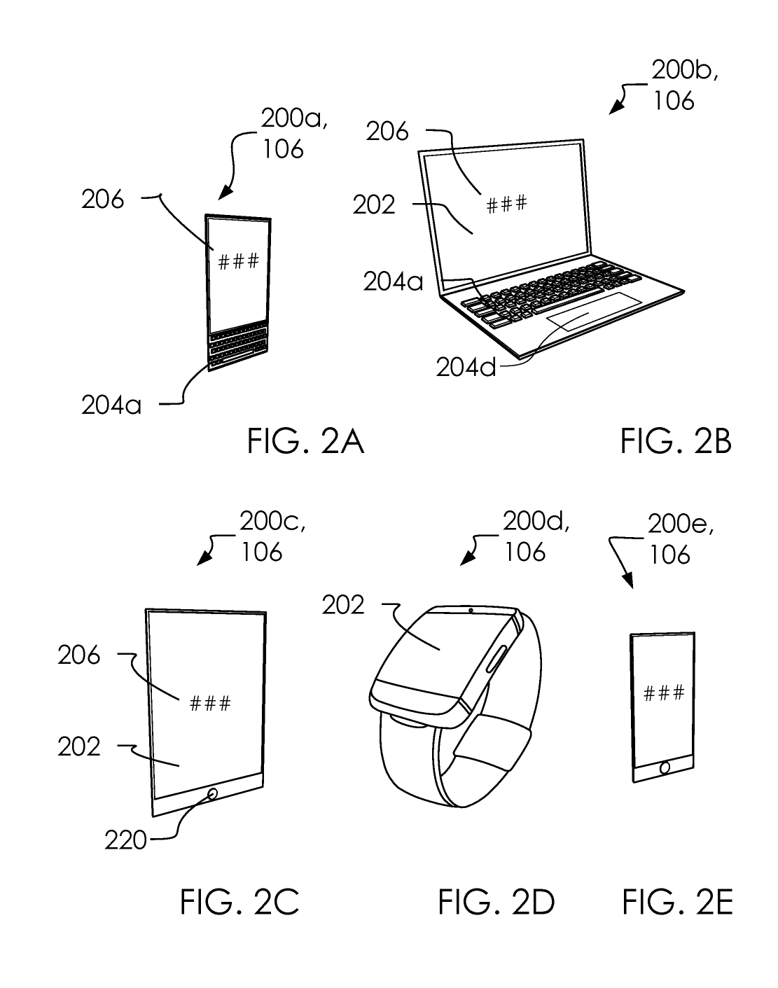

FIGS. 2A, 2B, 2C, 2D and 2E illustrate a perspective overview view of a mobile phone 200a, a personal computer 200b, a tablet 200c, a wearable computer 200d and a smartphone 200e, respectively.

For purposes of discussion, said user computers 106 can comprise many form factors, including but not limited to said mobile phone 200a, said personal computer 200b, said tablet 200c, said wearable computer 200d and said smartphone 200e. Each among said user computers 106 can comprise different variations of a screen 202 and one or more input devices 204, as is known in the art. For example, said tablet 200c can comprise said screen 202, and a home button 220; said personal computer 200b can comprise said screen 202, said one or more input devices 204, a keyboard 204a, and a trackball 204b; said mobile phone 200a can comprise said keyboard 204a, and said trackball 204b. In one embodiment, said one or more input devices 204 can comprise said keyboard 204a, said trackball 204b, one or more cameras 204c and a track pad 204d.

The useful definition of a computer has become more broadly understood to include mobile phones, tablet computers, laptops, desktops, and similar. For example, Microsoft® and Apple® have attempted to merge devices such as a tablet computer and a laptop computer by including touchscreens and pen input with specialty operating systems and desktop operating systems.

Despite different form-factors, said user computers 106 can have similar basic hardware. In addition to said one or more input devices 204 outlined above, said user computers 106 can comprise wireless communication device, such as RFID/NFC protocols, 802.11x, and similar. In one embodiment, said screen 202 can comprise a touch screen. In one embodiment, said track pad 204d can function similarly to a computer mouse as is known in the art. In one embodiment, said tablet 200c and/or said personal computer 200b can comprise a Microsoft® Windows® branded device, an Apple® branded device, or similar.

Said trading system 100 can comprise a data 206, as discussed herein. In one embodiment, said user computers 106 can be used to input and view said data 206. In one embodiment, said data 206 can be input into said user computers 106 by taking pictures with one of said one or more cameras 204c, by typing in information with said keyboard 204a, or by using gestures on said screen 202. Many other data entry means for devices like said user computers 106 are well known and herein also possible with said data 206.

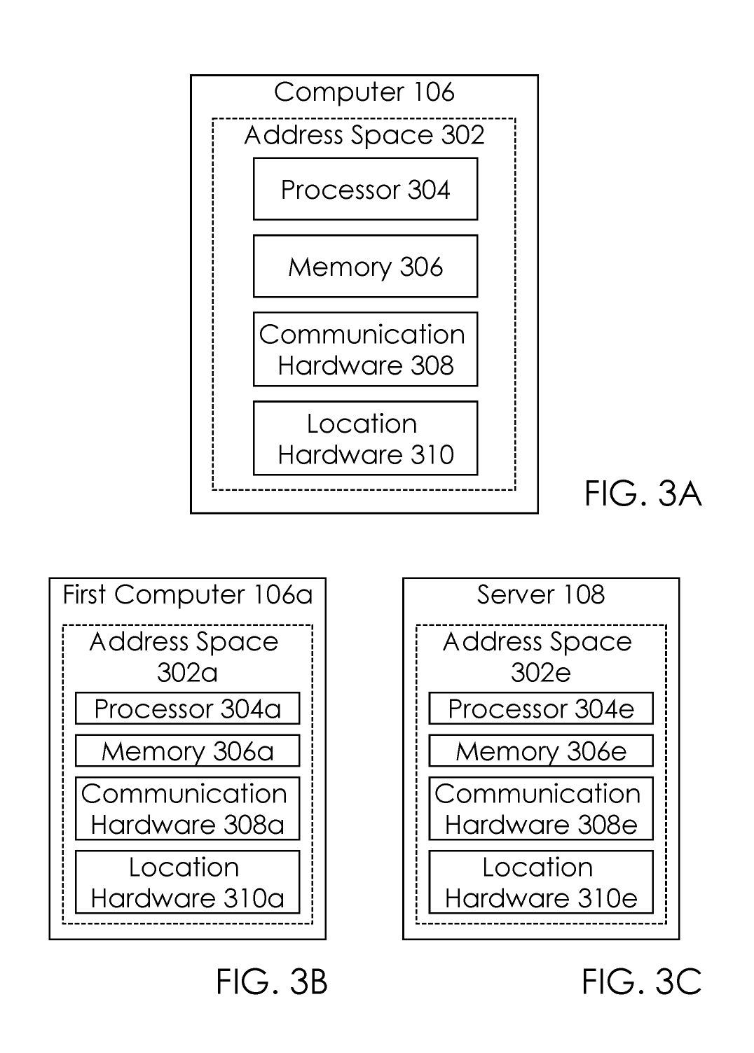

FIGS. 3A, 3B and 3C illustrate view of an address space 302, an address space 302a and an address space 302d, respectively.

In one embodiment, said address space 302 can comprise a processor 304, a memory 306, a communication hardware 308 and one or more location hardware 310.

In one embodiment, said address space 302a can comprise a processor 304a, a memory 306a, a communication hardware 308a and a first location hardware 310a; an address space 302b can comprise a processor 304b, a memory 306b, a communication hardware 308b and a second location hardware 310b; an address space 302c can comprise a processor 304c, a memory 306c, a communication hardware 308c and a third location hardware 310c; said address space 302d can comprise a processor 304d, a memory 306d, a communication hardware 308d and a fourth location hardware 310d; and an address space 302e can comprise a processor 304e, a memory 306e, a communication hardware 308e and a fifth location hardware 310e.

In one embodiment, said user computers 106 can comprise said address space 302; wherein, said first consumer computer 106a, said second consumer computer 106b, said first merchant computer 106c, said second merchant computer 106d and said trading system server 108 can respectively comprise said address space 302a, said address space 302b, said address space 302c, said address space 302d and said address space 302e.

Each among said user computers 106 and said trading system server 108 can comprise an embodiment of said address space 302. In one embodiment, said address space 302 can comprise said processor 304, said memory 306, and said communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required said data 206 has been gathered for said data management system and method. In one embodiment, said data 206 can include data which said user computers 106 can populate automatically, such as a date and a time, as well as data entered manually. Once a portion of gathering data has been performed said data 206 can be sent to said communication hardware 308 for communication over said network 112. Said communication hardware 308 can include a network transport processor for packetizing data, communication ports for wired communication, or an antenna for wireless communication. In one embodiment, said data 206 can be collected in said user computers 106 and delivered to said trading system server 108 through said network 112.

In one embodiment, said user computers 106 can comprise said address space 302a, said processor 304a, said memory 306a, and said communication hardware 308a. Likewise, in one embodiment, said trading system server 108 can comprise said address space 302d, said processor 304d, said memory 306d, and said communication hardware 308d.

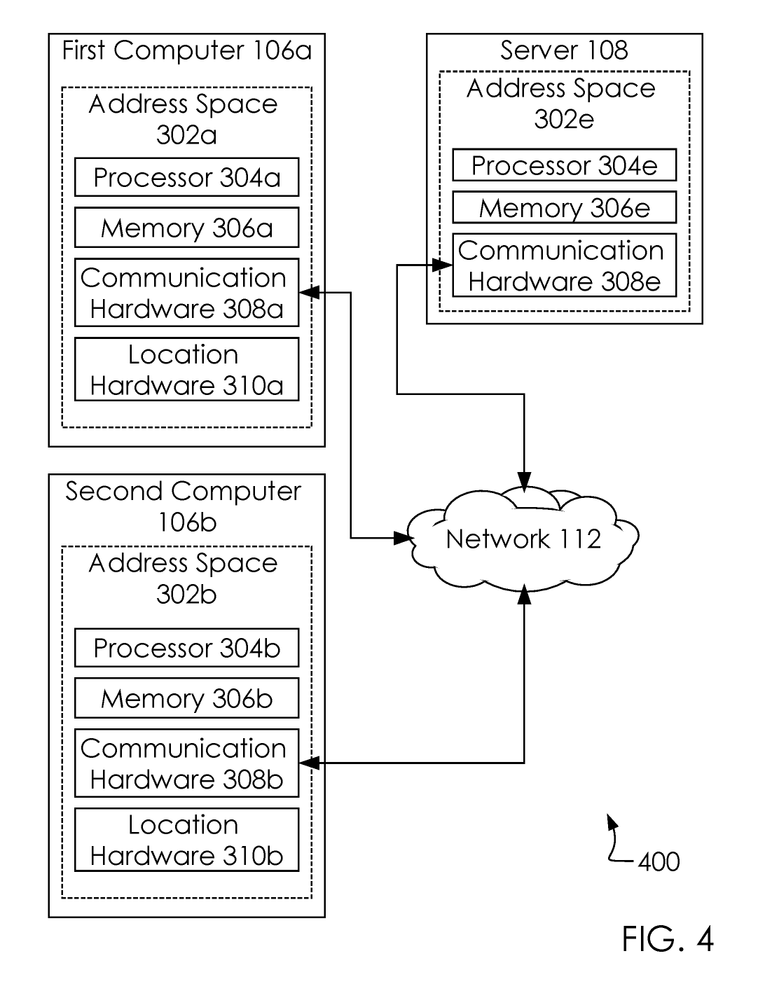

FIG. 4 illustrates a communication diagram 400.

In one embodiment, said first consumer computer 106a, said second consumer computer 106b and said trading system server 108 can communicate with one another over said network 112 using said communication hardware 308, said communication hardware 308a, said communication hardware 308b and said communication hardware 308e, as illustrated.

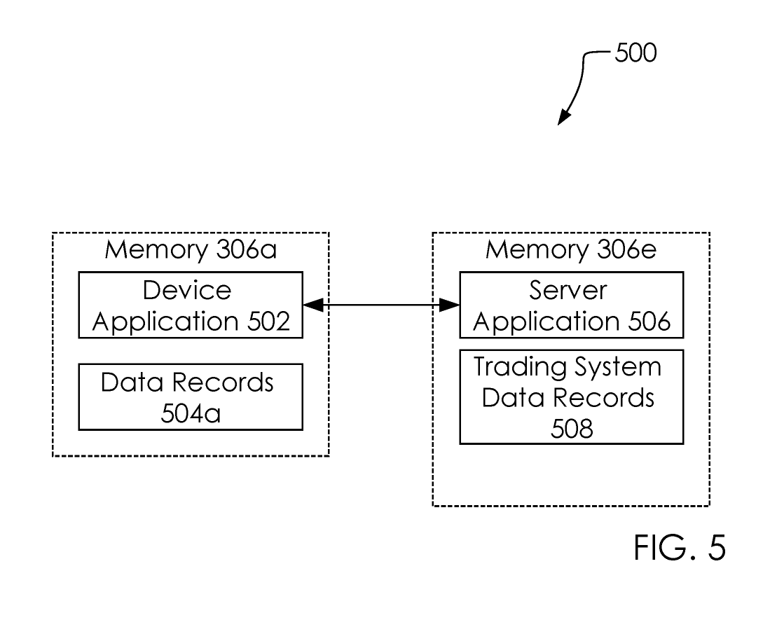

FIG. 5 illustrates view of an application interaction diagram 500 demonstrating interaction between a device application 502 and a server application 506.

In one embodiment, said memory 306a can comprise said device application 502; said memory 306d can comprise said server application 506.

In one embodiment, each among said user computers 106 can comprise data records related to said trading system 100; referred to here as a data records 504a, a data records 504b, a data records 504c and a data records 504d.

Herein, said trading system 100 can comprise said device application 502 on a portion of said user computers 106 and said server application 506 on a portion of said trading system server 108, each being configured to communicate with one another to implement said trading system 100 and associated methods.

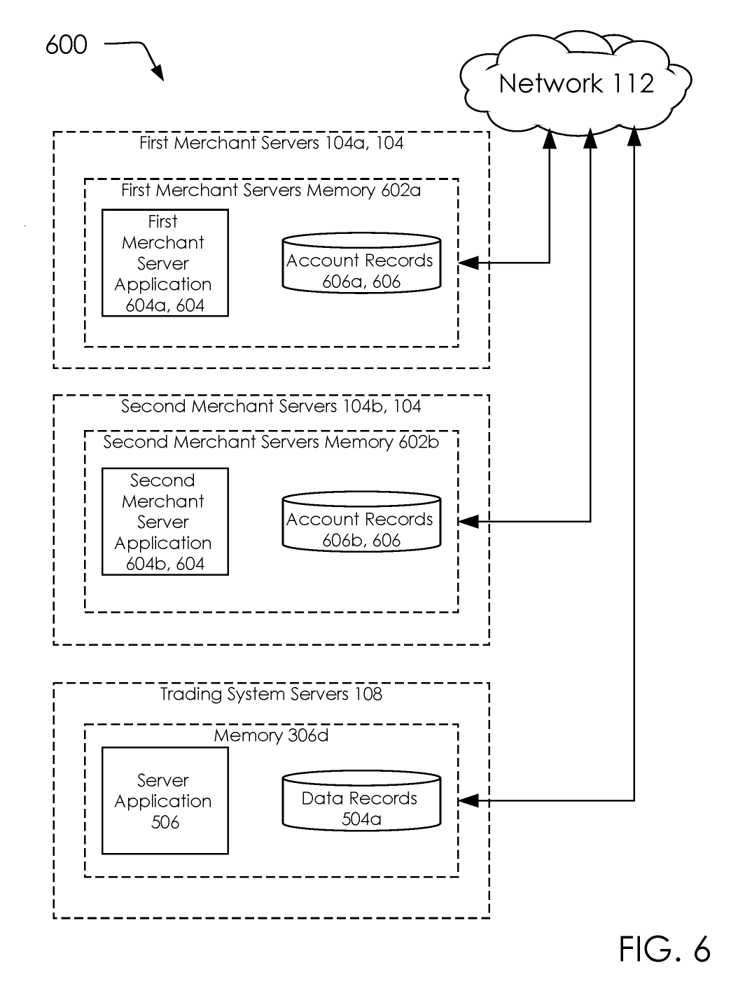

FIG. 6 illustrates view of a server interaction diagram 600.

In one embodiment, one or more system data records 602 can comprise a first system data record 602a, a second system data record 602b and a third system data record 602c.

In one embodiment, one or more Merchant server applications 604 can comprise a first Merchant server application 604a, a second Merchant server application 604b and a third Merchant server application 604c.

In one embodiment, one or more merchant account records 606 can comprise a first merchant account record 606a, a second merchant account record 606b and a third merchant account record 606c.

In one embodiment, said first merchant server 104a can comprise said first system data record 602a, said first Merchant server application 604a and said first merchant account record 606a; said second merchant server 104b can comprise said second system data record 602b, said second Merchant server application 604b and said second merchant account record 606b; and said third merchant server 104c can comprise said third system data record 602c, said third Merchant server application 604c and said third merchant account record 606c.

In one embodiment, said trading system 100 can coordinate communication between said merchant servers 104, said user computers 106 and said trading system server 108.

In one embodiment, said server application 506 can communicate among said one or more Merchant server applications 604 of said merchant servers 104 for the benefit of said one or more merchant users 120 and said two or more consumer users 118.

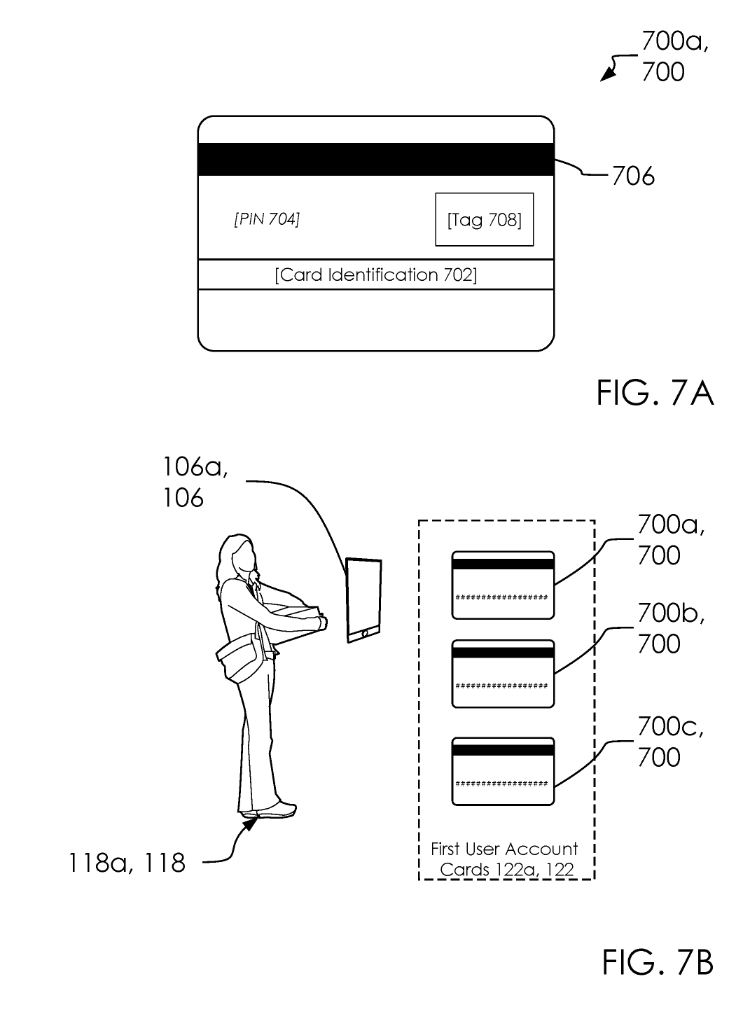

FIGS. 7A and 7B illustrate an elevated back side view of a first merchant card 700a and view of said first consumer user 118a with one or more merchant cards 700, respectively.

In one embodiment, said one or more merchant cards 700 can comprise said first merchant card 700a, a second merchant card 700b, a third merchant card 700c, a fourth merchant card 700d, and a fifth merchant card 700e. In one embodiment, each among said one or more merchant cards 700 can comprise an account identification 702, a PIN 704, a magnetic strip 706 and an electronic tag 708.

Relationships between said one or more merchant cards 700 and said two or more consumer users 118 can be many to many. For example, in one embodiment, said first user account cards 122a can comprise said first merchant card 700a, said second merchant card 700b and said third merchant card 700c; and said second user account cards 122b can comprise said fourth merchant card 700d and said fifth merchant card 700e. That is, in one embodiment, said first consumer user 118a can comprise a plurality of said one or more merchant cards 700, as illustrated and referred to as said first user account cards 122a. Likewise, said second consumer user 118b can comprise said second user account cards 122b (such as said third merchant card 700c and said fourth merchant card 700d). Records related to said second user account cards 122b can be understood without illustration.

In one embodiment, records related to said one or more merchant cards 700 can be stored on said merchant servers 104 in order to match account records with said one or more merchant cards 700 at the time of a transaction, as is known in the art.

Said one or more merchant cards 700 can represent credit accounts, debit accounts, merchant awards and loyalty programs and similar. Accordingly, a one or more of said two or more consumer users 118 can comprise a one or more of said one or more merchant cards 700, as is known in the art.

One objective of said trading system 100 can comprise managing privileges and rights previously captured on individual accounts and cards. For example, in one embodiment, said first consumer user 118a can have a free coffee from said first merchant user 120a stored on said first merchant card 700a, while said second consumer user 118b can have a free sandwich from said second merchant user 120b on said fourth merchant card 700d. In one embodiment, said trading system 100 can facilitate the exchange of the free coffee for the free sandwich as between at least two among said two or more consumer users 118.

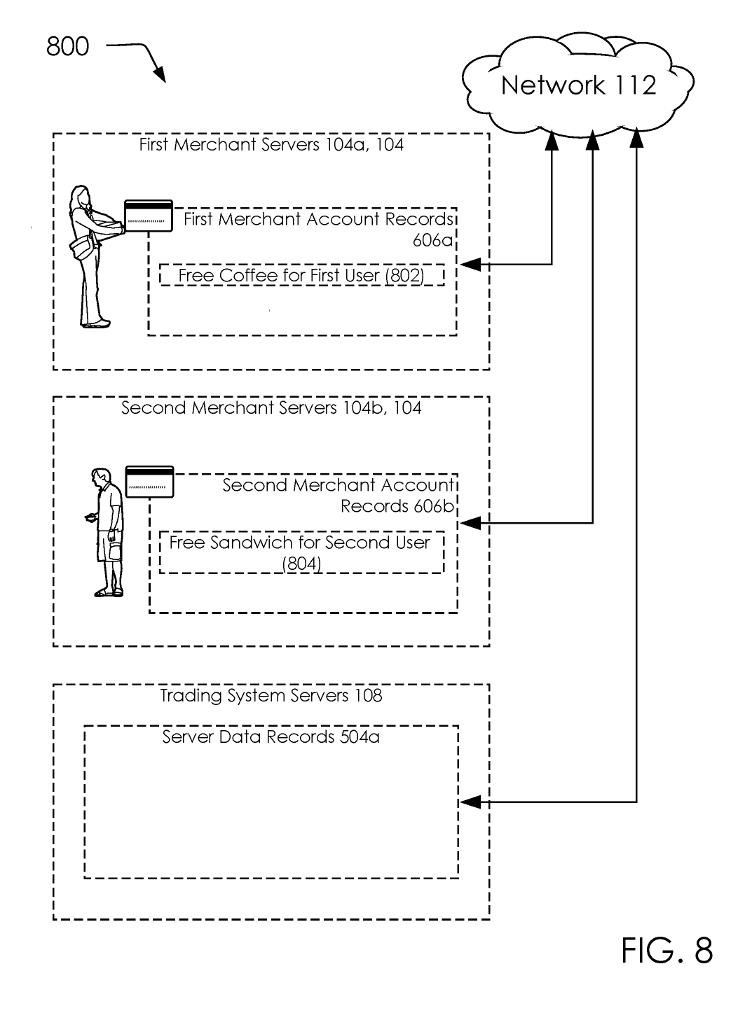

FIG. 8 illustrates a flow chart view of a initial accounts status 800.

In one embodiment, said initial accounts status 800 can comprise said first consumer user 118a owning a first credit 802 in said first merchant account record 606a, and said second consumer user 118b owning a second credit 804 in said second merchant account record 606b.

In one embodiment, said trading system 100 can comprise storing said one or more merchant account records 606 in said merchant servers 104; such as said first merchant account record 606a in said first merchant server 104a, said second merchant account record 606b in said second merchant server 104b, and said data records 504a in said trading system server 108. For example, in one embodiment, said first credit 802 can be stored in said first merchant account record 606a and said second credit 804 can be stored in said first merchant account record 606a, where said first consumer user 118a owns said first credit 802 and said second consumer user 118b owns said second credit 804; said first merchant server 104a and said first merchant account record 606a belong to said first merchant user 120a; and said second merchant server 104b and said second merchant account record 606b belong to said second merchant user 120b.

As illustrated in said initial accounts status 800, said two or more consumer users 118 each own their credits with respect to said one or more merchant users 120, as is known in the art.

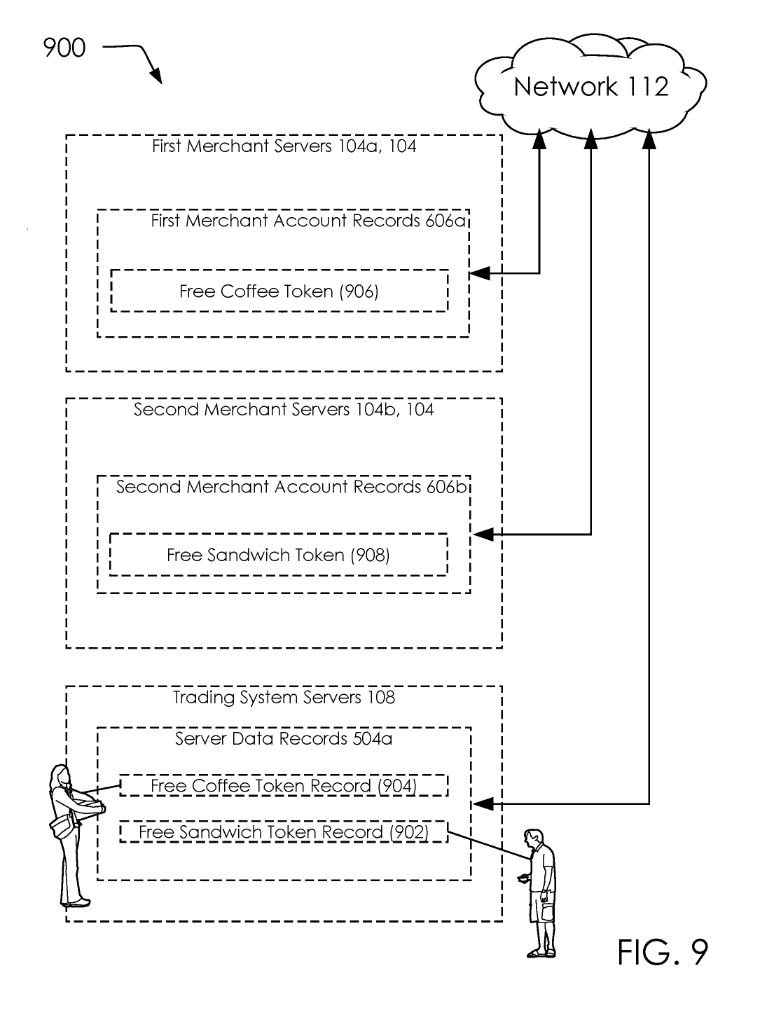

FIG. 9 illustrates a flow chart view of an assignment view 900.

In one embodiment, said data records 504a for said trading system server 108 can comprise a first token record 902 and a second token record 904; and said first merchant account record 606a can comprise a first token 906 and said second merchant account record 606b can comprise a second token 908. In one embodiment, said first token 906 and said second token 908 can be referred to together as a two or more tokens 910.

In one embodiment, said assignment view 900 can comprise a view of said trading system 100 with credits being assigned between users on said trading system server 108. Wherein, said first merchant account record 606a and said second merchant account record 606b hold said first token 906 and said second token 908.

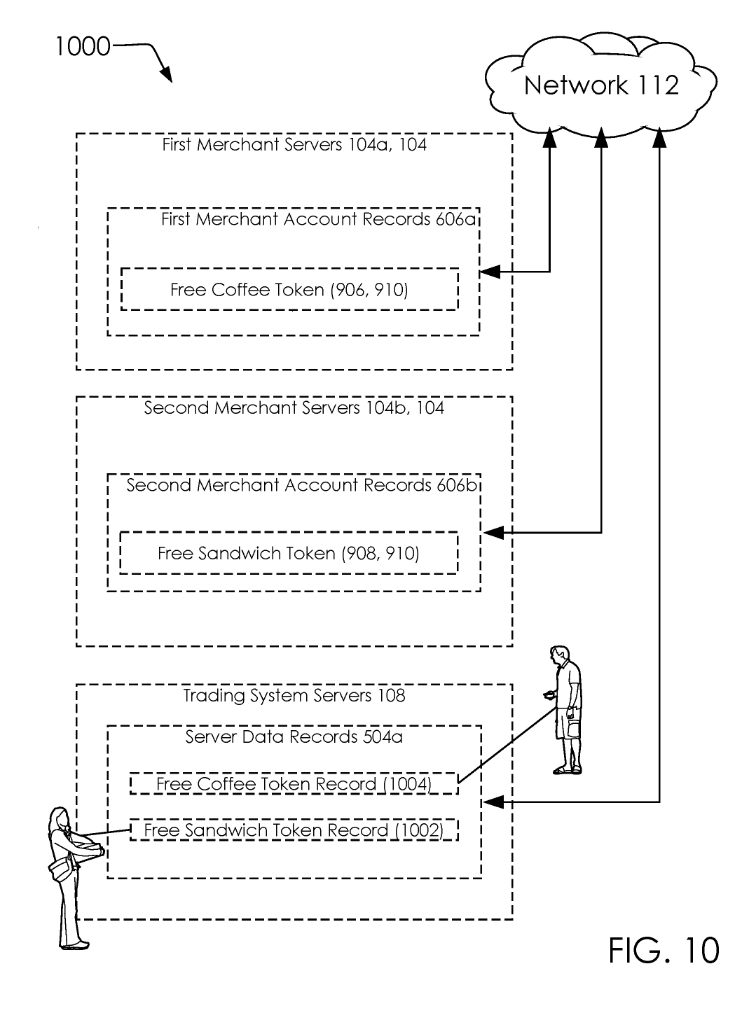

FIG. 10 illustrates view of an adjusted credits view 1000.

In one embodiment, said data records 504a of said trading system server 108 can comprise a second credit for first user 1002 and a first credit for second user 1004, however no change has occurred in said merchant servers 104 for said one or more merchant account records 606 which still hold said two or more tokens 910 (here, said first token 906 and said second token 908).

In one embodiment, said trading system 100 can facilitate the trade and marketing of credits as between said two or more consumer users 118 and said one or more merchant users 120, as illustrated.

Further, said one or more merchant users 120 can market to said two or more consumer users 118 so as to encourage loyalty or new customer development.

In one embodiment, said one or more merchant users 120 can limit transfers of credits across said trading system 100 according to preferences. In one embodiment, said trading system 100 can provide a platform for managing all credits and loyalty bonuses so as to eliminate the need for said one or more merchant account records 606 altogether.

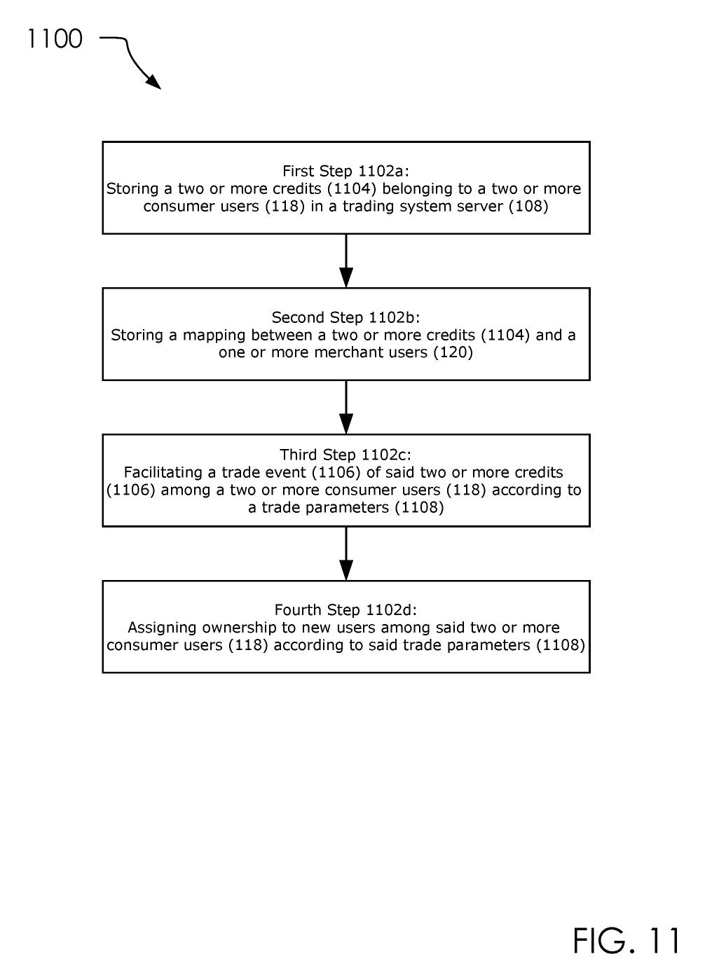

FIG. 11 illustrates view of a method of using a trading system 1100.

In one embodiment, said method of using a trading system 1100 can comprise one or more steps 1102 (which can comprise a first step 1102a, a second step 1102b, a third step 1102c and a fourth step 1102d).

In one embodiment, said trading system 100 can comprise said method of using a trading system 1100, said one or more steps 1102, a two or more credits 1104, a trade event 1106 and a trade parameters 1108.

Said method of using a trading system 1100 can comprise a method of using said trading system 100, as illustrated.

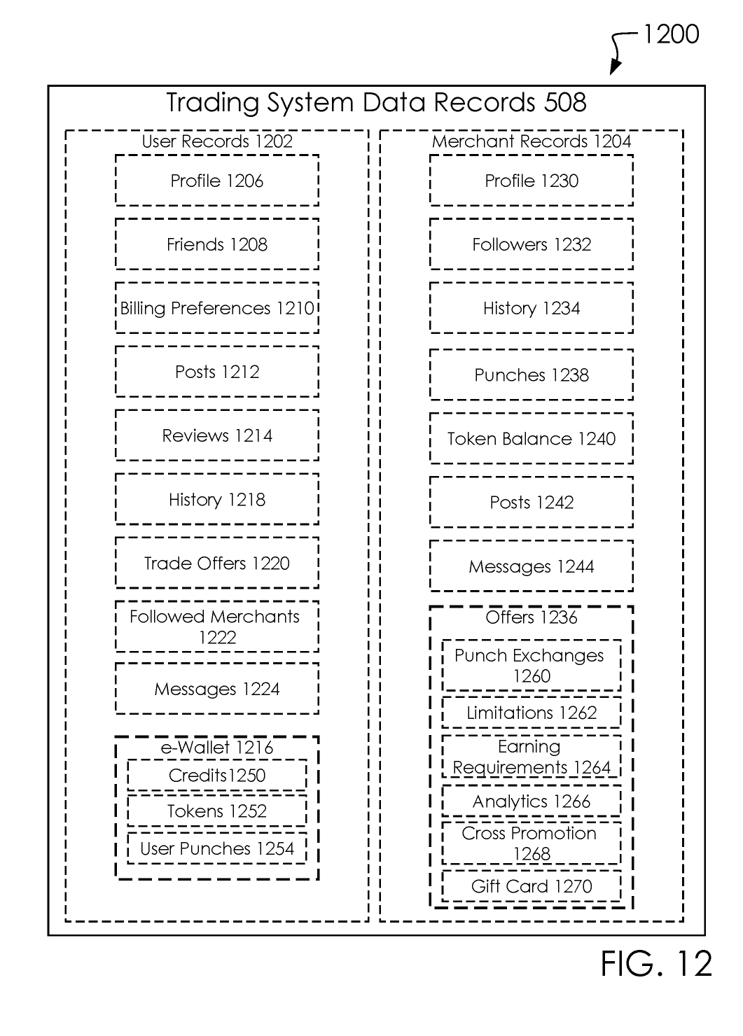

FIG. 12 illustrates a trading system records detail 1200 of a trading system data records 508.

In one embodiment, said trading system records detail 1200 can comprise an user records 1202 and a merchant records 1204. Said user records 1202 can comprise a profile 1206, a friends 1208, a billing preferences 1210, a posts 1212, a reviews 1214, an e-wallet 1216, a history 1218, a trade offers 1220, a followed merchants 1222 and a messages 1224. Said merchant records 1204 can comprise a profile 1230, a followers 1232, a history 1234, an offers 1236, a punches 1238, a token balance 1240, a posts 1242 and a messages 1244.

In one embodiment, said trading system 100, and specifically said server application 506, can comprise records related to said two or more consumer users 118 (with said user records 1202) and said one or more merchant users 120 (with said merchant records 1204). said server application 506 can manage credits, offers and ownership on a social platform.

Said profile 1206 and said profile 1230 can related to said two or more consumer users 118 and said one or more merchant users 120, respectively.

Likewise, said posts 1212 and said posts 1242 can related to postings on a newsfeed by the respective users. Said messages 1224 and said messages 1244 can comprise posts, direct messages and communication between users of the system, whether vendor, consumer or admin. Said posts 1212 can include posts by a user on other social networks if linked to the current system. merchants and friends can have the ability to insert posts into a news feed for other users, as is known in the art. Additionally offers (said offers 1236) from merchants can be made to users of the system. in cases where said offers 1236 are free, a user can add them to said e-wallet 1216 merely by clicking on the offer. Alternatively where said offers 1236 are offered for sale, users can buy them with a payment stored in said billing preferences 1210 or with credit stored in said e-wallet 1216.

Said followed merchants 1222 and said followers 1232 can comprise a cross reference between merchants and consumers. Said followed merchants 1222 can be created when to said two or more consumer users 118 selects an option to “follow” one among said one or more merchant users 120, as is known in the art.

Said friends 1208 can comprise cross references among said user records 1202, as is known in the art.

Said history 1218 and said history 1234 historical records (for any and all of said user records 1202 and said merchant records 1204), as is known in the art.

Said billing preferences 1210 can comprise a link to an account related to users of the system. wherein, users can purchase tokens, offers, and/or credits with cash. The system can be configured to receive payments through credit cards, trademarked platform payment systems such as Apple, Samsung, Google, Fitbit or other payment systems, as is known in the art.

Said reviews 1214 can comprise consumer reviews of products, services and locations related to merchants on the system. Said reviews 1214 can comprise video, audio, pictures, text or similar having been entered into the system by its users and lined to one or more among the merchants.

Said e-wallet 1216 can comprise a summary of all a credits 1250) including cash credits and said offers 1236 (earned, traded, accepted and purchased of from merchants). In one embodiment, items in said e-wallet 1216 can correspond to an tokens 1252 accounted for in said token balance 1240. Said e-wallet 1216 can also store an user punches 1254 associated with said punches 1238 offered by merchants. In one embodiment, said user punches 1254 can be redeemed for said tokens 1252 and said user punches 1254.

Said trade offers 1220 offers by one user of items in said e-wallet 1216 with said trade parameters 1108 associated with a trade. Wherein, other users can ignore said trade parameters 1108 or initiate said trade event 1106, as discussed above.

Merchants can use data stored in said followers 1232 for marketing and targeted offers. Further, the system can be configured to create analytics related to said followers 1232 and other users according to preferences.

Said punches 1238 can comprise digital records of punch cards and can be configured to automatically add a redeemable credit to said e-wallet 1216 for users with enough punches. For example, a user might get a free coffee after purchasing six coffees from a merchant.

Said token balance 1240 a calculation of all unredeemed tokens held by consumers.

In one embodiment, said offers 1236 can be made by merchants with various qualities. Said offers 1236 can comprise a punch exchanges 1260, a limitations 1262, an earning requirements 1264, an analytics 1266, a cross promotion 1268, and a gift cards 1270.

Said punch exchanges 1260 can comprise a definition of what qualifies as a single punch and how many punches must be exchanged in order to earn one or more of said tokens 1252.

Said limitations 1262 can comprise limits on offers such as geo-fencing to limit locations for redemption, expirations, and/or a flag to indicate whether a token is exchangeable or how many times it may be exchanged.

Said earning requirements 1264 can comprise a one or more prerequisites which must be met before a token is issued to a user. Examples of prerequisites can comprise requirements for visiting stores, uploading videos or pictures, or similar requirements.

Said analytics 1266 can comprise merchant specific data generated from analyzing said posts 1212, said reviews 1214, said e-wallet 1216, said history 1218, said trade offers 1220, said messages 1224, said history 1234, said token balance 1240, said posts 1242 and said messages 1244 or similar.

Said cross promotion 1268 can comprise cross references to others among said merchant records 1204, said offers 1236 or said one or more merchant users 120.

Said gift cards 1270 can comprise gift cards as is known in the art. In one embodiment, said gift cards 1270 can be sold by said trading system 100 at a custom rate such as half price or similar, according to the preferences of said one or more merchant users 120.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method of using a trading system of a trading system, comprising:
storing a two or more credits belonging to a two or more among a two or more consumer users in a trading system server;
storing a mapping between said two or more credits and one or more merchant users;
facilitating a trade event of said trade event among two or more among said two or more consumer users according to a trade parameters; and
assigning ownership of said two or more credits to new owners among said two or more consumer users according to said trade parameters.
